(19) United States
(12) Patent Application Publication
(10) Pub. No.: US 2003/0088522 A1
(43) Pub. Date: May 8, 2003

(54) Apparatus and method for simulating artificial intelligence over computer networks

(76) Inventor: Gregory J. Czora, Mountain View, CA (US)

Correspondence Address: Henneman & Saunders, 714 W. Michigan Ave., Three Rivers, MI, 49093, US

(21) Appl. No.: 10/266,171

(22) Filed: Oct. 7, 2002

Related U.S. Application Data
(63) Continuation-in-part of application No. 09/257,863, filed on Mar. 2, 1999, now abandoned.

(51) Int. Cl. G06F 17/60

(52) U.S. Cl. 705/80

(57) ABSTRACT

An Internet based simulated artificial intelligence system (10) and associated method (100) for brokering expertise, services, information, and the like by remote communication such as over the Internet (12). Seekers (16a) and providers (16b) register personal information and information about services sought and available, respectively. A brokering computer (18) matches information obtained in registration operations (106, 118, 126). A matching operation (138) results in either no match, an exact match or a near match. In the case of a near match, a negotiation operation (50) is initiated. It either the successful culmination of the negotiation operation (50) or in the case of an exact match, the negotiated service is rendered in a provider sends work product operation (144) and monetary considerations are accomplished in a payoff operation (146).

### RELATED APPLICATIONS

This application is a continuation-in-part of U.S. application Ser. No. 09/257,863, entitled Apparatus And Method For Brokering Expertise, which was filed on Mar. 2, 1999, and which is incorporated herein by reference in its entirety.

### TECHNICAL FIELD

The present invention relates to the fields of Artificial Intelligence (AI), the simulation of an advanced AI like computer interface using existing components, and the use thereof for computer aided data communication and exchange of information. The predominant current usage of the present inventive simulated AI method and apparatus is in connecting persons through mainframe transaction systems and/or the Internet, wherein it is desirable to reach the widest possible audience while retaining the required anonymity.

### BACKGROUND ART

There exist many methods for accomplishing AI and also for doing business, and many of these have been adapted for use using computers and/or the Internet. For instance, an example of the state of the art in AI systems is a system called Cyc, that is being developed by Doug Lenat. An example of a prior art method for doing business is found in U.S. Pat. No. 5,749,207, issued to Walker et al., which teaches a method and apparatus for accomplishing transactions using buyer-driven conditional purchase offers. This is, in effect, an adoption of the traditional “reverse auction” method of doing business for use in the Internet environment.

However, the state of the art AI systems have not been very successful, even after the investment of many years and millions of dollars. Moreover, traditional methods of doing business (both those which have been modified for use in the computer environment and those which have been practiced using “pencil and paper” book keeping methods) have not been well adapted to the buying and selling of information and intangibles such as “expertise”. That is, when one individual wishes to purchase the knowledge and expert opinion or work of another, it has traditionally been a rather hit and miss prospect to find a person with the required expertise—and particularly one who is willing to perform the required service at a reasonable price. This situation has not been significantly improved by the advent of the computer age and the promulgation of the Internet. Existing systems for bartering over the Internet have all been adapted for the exchange of goods or fungible services, such as airline passenger service or on-line auctions such as eBay™. AI systems have been used with some of these transaction and information search systems to aid users, but they have not been very successful. All that state of the art AI systems have been able to accomplish for Internet search engines, for example, is to be a minor software utility to the Lycos™ search engine. This is all that has been accomplished even after twelve years of hard work by some of the best AI systems designers and programmers, the creation of a database containing 1.5 million facts, and system development cost of over $50 million.

This situation regarding the use of AI in the prior art is particularly unfortunate, since the Internet provides us with a never before seen opportunity to freely communicate with other individuals the world over. Furthermore, although there is a great deal of information stored in computers and available on the Internet (only a some of which is easy to find and access), the great bulk of expert information in the world remains in the minds of individuals, with no easy way to access it. Despite the availability of so called “expert systems”, the ability of computers to provide the specific expertise and experience of a human expert is still lacking, and will probably be so for some time to come.

There are known advantages to an artificial intelligence type of human/computer interaction. Among these are anonymity. It may be that a person would prefer to deal with a non-judgmental and impersonal persona. Another advantage is the thoroughness with which a problem is addressed. However, as discussed above, there are many disadvantages to present day AI systems. Among these are that the computerized AI may simply be incapable of understanding a given problem as presented by the human user and/or may be incapable of solving the problem, and/or may be incapable of communicating a solution to the user.

It would be desirable to find some way to use the communication capabilities of computers and the Internet to bring together those persons having particular expertise, knowledge, or capabilities, with persons requiring the same. In addition, it would be desirable for users of such computers to be able to communicate and get results in a manner similar to that depicted in science fiction movies and television shows (such as Star Trek™), by dealing with a computer system or robot that seems to the user to be another conscious being like her or himself, so that the user can just communicate with the system using ordinary human languages to ask it questions and have the system communicate with the user using the same human language to provide the answers. However, to the inventor's knowledge, no such method, system, or apparatus has existed in the prior art.

### DISCLOSURE OF INVENTION

Briefly, a preferred embodiment of the invention includes a networked brokering computer connected to the Internet and running transaction and Web application software whereby providers of a service, expertise, information, or the like can register their availability to provide such, along with an asking price and other information. Seekers can register their desire to purchase a service, expertise, information or the like along with an offer price and other information. A matching operation matches seekers and providers and both are notified if a match is attained. All communications and transactions are through the brokering computer so that anonymity is retained in order to create and sustain the illusion of the intermediary interface of a simulated AI consciousness. Seekers and providers are notified of near matches also by the simulate AI consciousness interface, and a negotiation process is initiated whereby the seeker and provider can try to resolve any differences in their requirements. An automatic monitor process monitors many of the other operations of the method to insure correct matches, the absence of illegal transactions, and the like State of the art Al software also monitors and assists the brokering process and resolves and satisfies requests escalated to it by the automatic monitor when the state of the art transactions system fails to do so. Human beings also actively and anonymously oversee, manage, and participate in the brokering process. If the state of the art AI cannot satisfy and resolve a user request, it is escalated to the human managers and processors who can use their real conscious intelligence, knowledge, skills, and expertise to satisfy and resolve the user request through the intermediary of the simulated AI consciousness, renegotiate the request, or inform the user the request is impossible to satisfy at that time. An advantage of the present invention is that persons offering a particular expertise, or personal or professional service can make their presence known to a simulated AI interface, which then can make their requests known to other users of the Internet who are providers of information and expertise.

A further advantage of the present invention is that persons seeking a particular expertise, or personal or professional service can find the information or expertise being offered over the Internet (or an organization's intranet) as if they had access to an advanced AI computer system.

Yet another advantage of the present invention is that a price for services can be negotiated without the necessity of personal communications.

Still another advantage of the present invention is that anonymity is of the human processors in the system is maintained, thereby maintaining the illusion of the advanced science fiction like consciousness.

Yet another advantage of the present invention that it can be lucrative to provide a service matching possessors and seekers of expertise, thereby making practical the establishment of such a much needed service.

Still another advantage of the present invention is that users will find it easier to communicate with a simulated human consciousness than with state of the art network search engines, Web pages, and state of the art AI, because none of these technologies have the intelligence and language ability of a real human being, even one who is role playing an advanced AI persona.

These and other objects and advantages of the present invention will become clear to those skilled in the art in view of the description of the best presently known mode of carrying out the invention and the industrial applicability of the preferred embodiment as described herein and as illustrated in the several figures of the drawing.

### BRIEF DESCRIPTION OF THE DRAWINGS

FIG. 1 is block schematic diagram of an example of an Internet based expertise brokering apparatus according to the present invention;

FIG. 2 is a flow diagram depicting an Internet based expertise brokering method according to the present invention;

FIG. 3 is an example of a registration screen according to an embodiment of the present invention;

FIG. 4 is an example of a provider information screen according to an embodiment of the present invention; and

FIG. 5 is an example of a seeker information screen according to an embodiment of the present invention.

### DETAILED DESCRIPTION OF THE INVENTION

The embodiments and variations of the invention described herein, and/or shown in the drawings, are presented by way of example only and are not limiting as to the scope of the invention. Unless otherwise specifically stated, individual aspects and components of the invention may be omitted or modified, or may have substituted therefore known equivalents, or as yet unknown substitutes such as may be developed in the future or such as may be found to be acceptable substitutes in the future. The invention may also be modified for a variety of applications while remaining within the spirit and scope of the claimed invention, since the range of potential applications is great, and since it is intended that the present invention be adaptable to many such variations. A known mode for carrying out the invention is a hybrid system of networked computers and people. While this invention is described in terms of an example of a mode for achieving this objectives of this invention, it will be appreciated by those skilled in the art that variations may be accomplished in view of these teachings without deviating from the spirit or scope of the present invention. For example, the present invention may be implemented using any combination of computer programming software, firmware or hardware. As a preparatory step to practicing the invention or constructing an apparatus according to the invention, the computer programming code (whether software or firmware) according to the invention will typically be stored in one or more machine readable storage devices such as fixed (hard) drives, diskettes, optical disks, magnetic tape, semiconductor memories such as ROMs, PROMs, etc., thereby making an article of manufacture in accordance with the invention. The article of manufacture containing the computer programming code is used by either executing the code directly from the storage device, by copying the code from the storage device into another storage device such as a hard disk, RAM, etc. or by transmitting the code on a network for remote execution. The method form of the invention may be practiced by combining one or more machine readable storage devices containing the code according to the present invention with appropriate standard computer hardware to execute the code contained therein. An apparatus for practicing the invention could include one or more computers and storage systems containing or having network access to computer program(s) coded in accordance with the invention. As will be described in more detail hereinafter, practice of the invention can include a plurality of anonymous human managers and processors that add real, human conscious intelligence to the system. The computers run software programs that process the requests of seekers of information and expertise, and provide results by processing information and expertise from expert providers. The computers may also run state of the art AI software that adds automated intelligence to the invention. At some point, however, computer software and state of the art AI systems will not be able to resolve a user request, and so the inventive method will include steps to escalate operation to human processors who can resolve and satisfy a user's a request.

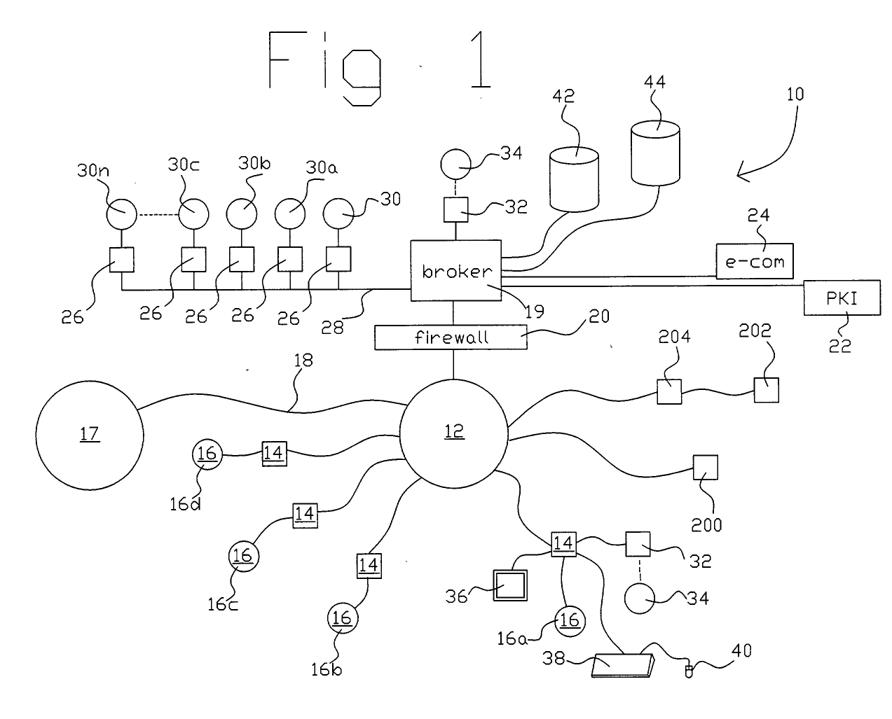

An example of a mode for carrying out the invention is an Internet based expertise brokering apparatus and method and associated human managers and processors that simulate an advanced AI interface, much like that found in science fiction movies and television shows, to the users of the system. One example of the inventive Internet based expertise brokering and AI simulation apparatus is depicted in an a block diagrammatic view in FIG. 1 and is designated therein by the general reference character 10. The Internet based brokering and AI simulation apparatus 10 is connected to the Internet 12. As one familiar with the Internet 12 will be familiar, an indefinite plurality (four are shown in the simplified example of FIG. 1) of computers 14 are connected to the Internet, and each computer 14 in this example will have associated therewith at least one human user 16. As can also be seen in the view of FIG. 1, additional network groups of information and/or expertise providers, designated as additional providers 17, may optionally be connected to the Internet 12 by a Virtual Private Network (“VPN”) 18, or the like.

In this present example, a brokering computer 19 and associated human managers 30 and processors 26 are connected to the Internet 18, preferably through a firewall 20 for preventing unwanted intrusion into or tampering with the brokering computer 19. Optionally connected to the brokering computer 19 are a public key infrastructure unit 22 and a e-commerce Web application server 24. Both the public key infrastructure unit 22 and the e-commerce server 24 are conventional in nature and their operation in conjunction with the present invention does not differ significantly from conventional usage with which one skilled in the art will be familiar. Briefly, the public key infrastructure unit 22 is provided to enable encoding and decoding of communications between the brokering computer 19 and the Internet 12, and the e-commerce server 24 is provided for allowing secured monetary transactions between the brokering computer 19 and the other computers 14 on the Internet 12. It will be recognized by one skilled in the art that the brokering computer 19 need not necessarily be a single computer, but rather can be a network of computers, or a main computer running in conjunction with one or more ancillary computers, depending upon the speed, capacity, and communications requirements of a particular iteration of the present invention.

As will be discussed in greater detail hereinafter, in the example depicted in FIG. 1, a plurality (three are shown in this example) of manager computers 26 and those for human expertise processors 30 are connected (as via a local area network 28) to the brokering computer 19. Each manager computer 26 will generally have associated therewith a human manager or human expertise processor 30-30n, or a person serving as both.

In the example of FIG. 1 are shown, by way of example only, a removable media drive 32 whereby software, including that containing the inventive method, can selectively be loaded into the computers 14 and the brokering computer 19 from a removable media 34. Each of the computers 14 connected to the Internet 12 and each of the manager computers will be equipped with a display screen 36, a keyboard 38, and a pointing device 40 (such as a mouse, a trackball, or the like) for input and output. For the sake of clarity in the drawing of FIG. 1, only one example each of the display screen 36, the keyboard 38 and the pointing device 40 is provided.

A provider data base 42 and a seeker data base 44, the function of which will be discussed in more detail hereinafter, are shown in the example of FIG. 1 appended to the brokering computer 19. It should be pointed out that the users of this system (information and expertise seekers) cannot tell whether they are communicating with other human beings or a sufficiently advanced AI that merely seems to be a conscious intelligence. This is the case because (without video) there is no way to discern the expertise provider using a computer at the other end of a network from that expertise provider's computer itself, if there is either a sufficiently advanced AI between the seekers and expertise providers, or if the expertise providers role play an advanced “science fiction” I like AI persona. This is a variation on the famous Turning Test developed by Alan Turing as a test for distinguishing and AI computer system from a non-AI computer system.

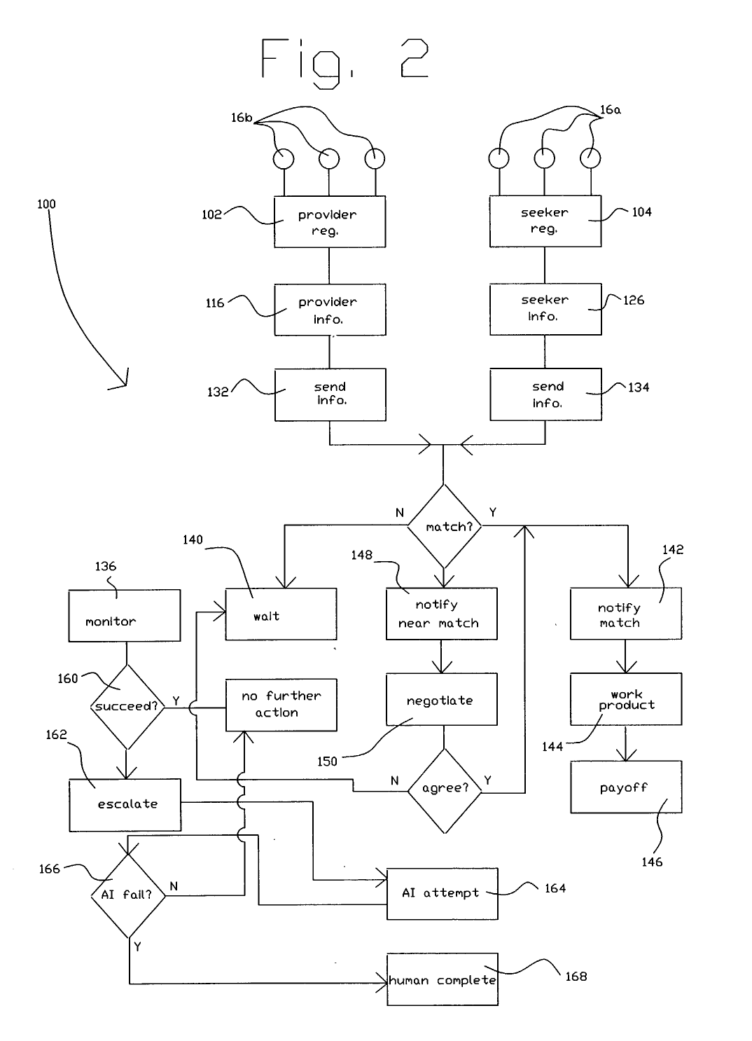

FIG. 2 is a flow diagram depicting some major operations of an example of the present inventive simulated AI method. In this example of the simulated AI method 100, a provider registration 102 and a seeker registration 104 are accomplished generally in parallel. It is anticipated that both the seeker registration 104 and the provider registration 102 will be accomplished to determine the identity of a seeker 16a or provider 16b, respectively. It will be recognized that, while three each of the seekers 16a and providers 16b are shown in the example of FIG. 2, in actual practice there will be a large indeterminate number of seekers 16a and providers 16b. It will further be recognized that the seekers 16a and the providers 16b are the users 16 depicted in FIG. 1, the distinction being the particular functions being presently accomplished as will be discussed hereinafter. Indeed, it is possible that the same user (FIG. 1) will, at various times, be both a seeker 16a and a provider 16b in different transactions, but they generally must interact anonymously through the simulated AI interface. The provider 16b is simply the person desiring to provide a service and the seeker 16a is the person desiring to purchase a service. In this context, the term “service” means essentially any type of personal or professional service, or expert knowledge, or the like which might be possessed by the provider 16b and which the seeker 16a might wish to obtain and that can be provided over a computer network.

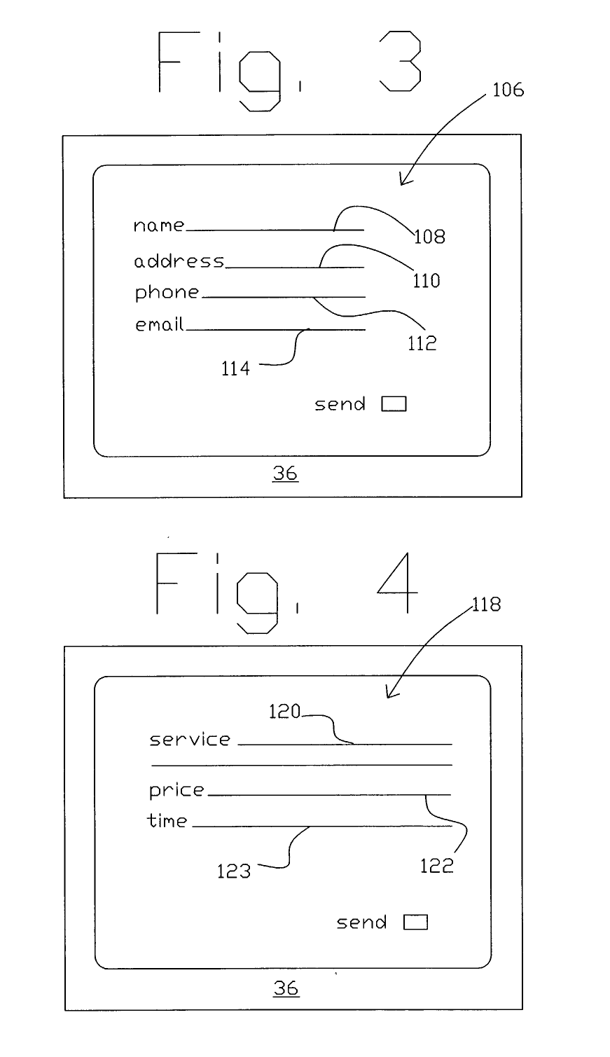

FIG. 3 is an example of a registration screen 106 such as might be displayed on the display screen 36 (FIG. 1) of the computer 14 (FIG. 1) during either the provider registration 102 or the seeker registration 104 operations of FIG. 2. As can be seen in the view of FIG. 3, this example of the registration screen 106 has a name field 108, an address field 110, a phone field 112 and an email field 114. The fields 108, 110, 112 and 114 are intended as examples only, in that essentially any type of information identifying or relevant to the users 16 might be solicited as a part of the registration 102, 104 operations.

One skilled in the art that the provider registration 102 and the seeker registration 104, as all of the operational steps of the simulated AI method 100, may be embodied as routines or subroutines (sometimes referred to as modules) to be stored in the memory of the computers 14 and/or brokering computers 19. Such modules can, for example, be downloaded to the computers 14 from the brokering computer 19 through the Internet 12 or, alternatively, can be provided on the removable media 34 and loaded into the computers 14 using the removable media drive 32. In the embodiment described in the example of FIG. 1, it is anticipated by the inventor that the software modules to perform the operational steps of the inventive method will generally reside in the brokering computer and will be sent, as required, to the computers 14 in the form of hyper text markup language (“HTML”) pages containing Java applets, wherein forms such as that shown in the example of FIG. 3 are embodied as applets such that interaction between the user 16 and the form 106 is enabled.

It is within the scope of the invention to provide alternative means or methods for avoiding the necessity for users 16 who have previously visited the registration screen 106 having to again provide the information requested therein. On skilled in the art will recognize that such information could be stored in a cookie in the computer 14 and provided to the brokering computer 19 upon connection of the brokering computer 19 with the computer 14 through the Internet 12. Another example would be to provide a registration number to the user 16 upon completion of the such that the user could enter the key number in lieu of the information requested in the fields 108, 110, 112 and 114. One skilled in the art will be familiar with such procedures.

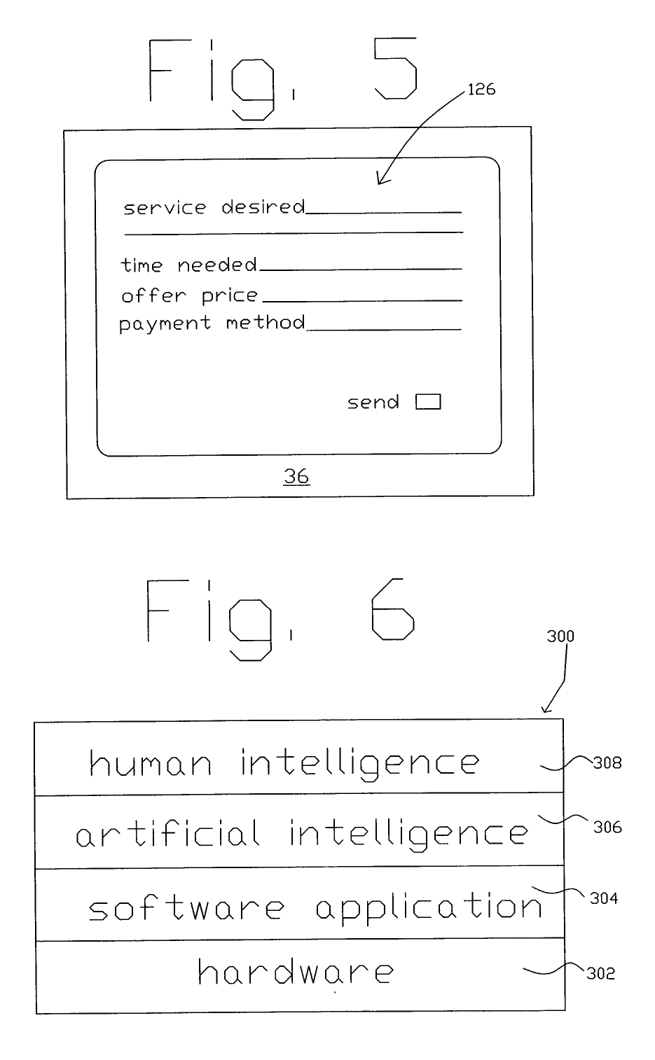

Following the provider registration operation 102, a provider information operation 116 obtains provider information about a particular transaction proposal. The information obtained in the provider registration operation 102, as discussed hereinafter, may collectively be referred to as a seller's offer 117. FIG. 4 is an example of a provider information screen 118 such as might be used in conjunction with the provider information operation 116. In the example of FIG. 4, the provider information screen 118 has a service field 120 wherein a provider 16b (FIG. 1) can describe the sort of service, information, expertise, or the like which he or she has to offer. In this example, a price field 122 is provided wherein the provider 16b can put a price for the service, or the like, described in the service field 120. A time field 123 requests a time for completion of the task or service described. It should be noted that the fields 120, 122 and 123 in the example of the provider information screen 118 are by no means exclusive of the information which might be requested and/or provided by the provider 16b during the provider information operation 116. Nor is the particular information discussed herein all necessary for the practice of the invention. For example, the price field 120 could be omitted from the provider information screen 118, in which case a price would probably be negotiated at a later stage in the overall operation.

Following the seeker registration operation 104 in the example of FIG. 2 is a seeker information operation 124. The information obtained in the seeker registration operation 116, as discussed hereinafter, may collectively be referred to as a buyer's requirement 125. FIG. 5 is an example of a seeker information screen 126 such as might be used in conjunction with the seeker information operation 124. In the example of FIG. 5, the seeker information screen 128 has a service desired field 128 wherein the seeker 16a can enter a description of the sort of service, information, expertise, or the like desired. A time needed field 129 is provided for the seeker 16a to enter a date by which the information, or the like, is needed. An offer price field 130 provides a place for the seeker 16a to enter a price which he or she offers for the service, or the like, described in the service desired field 128. A payment method field 131 is provided wherein the seeker 16a can enter information about how he or she intends to pay for the service, including credit card information and the like. Again, it should be noted that the fields 128, 129, 130 and 131 in the example of the seeker information screen 126 are by no means exclusive of the information which might be requested and/or provided by the seeker 16a during the seeker information operation 124, nor is the particular information discussed herein all necessary for the practice of the invention.

One skilled in the art will be familiar with the concept and process of filling out the fields 120, 122, 123, 128, 129, 130 and 131 in the provider information screen 118 and the seeker information screen 126, using the keyboard 38 and pointing device 40, examples of which are depicted in FIG. 1. One skilled in the art will also recognize that the particular examples of the screens 106, 118 and 126 depicted in FIGS. 3, 4 and 5, respectively, could be reconfigured in a nearly infinite number of ways. As just one example, the registration screen 106 could be combined with the provider information screen 118 into a single screen (not shown) for obtaining all necessary information from the provider 16b. Similarly, the registration screen 106 could be combined with the seeker information screen 126 to obtain all necessary information from the seeker 16a.

Referring again to the flow diagram of FIG. 2, in a send provider information operation 132 information obtained during the provider registration operation 102 and the provider information operation 116 are sent to the brokering computer 19 through the Internet 12. Similarly, in a send seeker information operation 134, information obtained during the seeker registration operation 104 and the seeker information operation 126 are sent to the brokering computer 19 through the Internet 12. The information from the seeker 16a is stored in the seeker data base 44 and the information from the provider 16b is stored in the provider data base 42. One skilled in the art will recognize that the provider data base 42 and the seeker data base 44 could readily be combined into a single data base, keeping in mind that it is desirable to retain the anonymity of the human expertise providers. The two separate data bases are depicted in the view of FIG. 1 by way of example only.

In the view of FIG. 2 can be seen a monitor operation 136 resides alongside the flow of operations depicted in the flow diagram of FIG. 1. This is because, in the monitor operation 136 information passed during various operations of the inventive simulated AI method 100 is passed on to the manager computers for monitoring. In the present embodiment of the invention, it is anticipated that such monitoring activity will be generally performed by the human managers 30. However, it is within the scope of the invention that artificial intelligence (“AI”) methods will be used to perform at least a substantial part of such monitoring activities and expertise processing, if the automatic transaction application software is unable to provide the information or expertise a user is seeking. Furthermore, if the AI methods also fail to satisfy the criteria that the user is seeking, the human managers will further escalate the user's request to real human processors who will either satisfy the request, renegotiate it, or inform the user that the request is impossible to satisfy at that time (all while role playing an advanced AI persona through the system's simulated AI interface to the users). In the view of FIG. 2 it can be seen that the information of the send provider information operation 132 and the send seeker information operation 134 are monitored in the monitor operation 136. The sort of thing that the managers 30 (FIG. 1) will be looking for here is incomplete information (which might have gotten by any conventional automation associated with the screens 106, 118 and 126 intended to help avoid such). The managers 30 might also look for a transaction that needs to be escalated to state of the art AI processors, a transaction that needs to be escalated to AI role playing human processors, the presence of a proposal for an illegal transaction, or the like.

In a matching operation 138 an attempt is made to match the information from the provider information operation 116 with that from the seeker information operation 126. It will be recognized that it is anticipated that there will be a great many providers 16b and a great many seekers 16a, such that the provider data base 42 and the seeker data base 44 will contain a great many iterations of variations of the information from the provider information operation 116 and the seeker information operation 126. The matching operation 138 will be done at least initially by the brokering computer 19, although all except exact matches will be sent to managers 30 as a part of the monitor operation 136, as shown in the example of FIG. 2) for potential human intervention, should both the automatic matching and transaction application, as well as the state of the art AI software fail to match a user's request.

It should be noted that, while the previous steps of the inventive simulated AI method 100 described herein will generally be repeated, as necessary, to accommodate additional seekers 16a and providers 16b, the matching operation 128 and steps introduced hereinafter will be repeated, as necessary, to accommodate the various iterations of information provided, and this need will be understood by anyone skilled in the art. For example, as shown in the example of FIG. 2, if there is no match for a particular set of data (from either a seeker 16a or a provider 16b) then that particular offer or request will be set aside to be tried again later (recycled to the matching operation 138) in a wait for next match operation 140. If, after some reasonable period of time, no automatic match is found, the request will be escalated to the state of the art AI software, and if that too fails, to a human processor role playing an advanced AI persona who can satisfy the request, renegotiate it, or inform the user the request is impossible at that time.

If the results of the matching operation 138 are an essentially perfect match of the seeker 16a and the provider 16b, then the seeker 16a and the provider 16b are each notified in a notify of match operation 142. Although it is not specifically shown in the flow diagram of FIG. 2, it is anticipated that both the seeker 16a and the provider 16b will be given an opportunity to opt out of the transaction at this point. For example, perhaps the seeker 16a has already obtained the information required, or perhaps the provider has taken on another assignment which would make impossible delivery within the time frame previously specified.

If neither the seeker 16a or the provider 16b opt out, the provider will provide the agreed upon work product through the brokering computer and the simulated AI interface 10 in a provider sends work product operation 144, whereupon the seeker is debited and the provider is credited, according to the prearranged terms, in a payout operation 146. In order to make the simulated AI method 100 economically viable, it is anticipated that a percentage of the agreed upon fee will be retained by the providers of the service accomplished using the inventive simulated AI method 100.

In the event of a “near match”, as determined in the matching operation 138 (as by a manager 30), both the seeker 16a and the provider 16b are notified through the simulated AI interface of the near match and of whatever is different between the offer by the provider 16b and the request by the seeker 16a in a notify of near match operation 148. Thereafter, a negotiation operation 150 is initiated whereby the seeker 16a and the provider 16b can negotiate with each other, but only (through the brokering computer 19 and its simulated advanced AI interface, so as to retain anonymity) to try to resolve any differences (such as a difference in price, delivery time, or the exact nature of the service being negotiated). If the seeker 16a and the provider 16b reach agreement, as indicated by an agreement decision operation 152 in the example of FIG. 2, then flow of the inventive operations is routed to the notify of match operation 142 by the simulated advanced AI interface. If the negotiate operation 150 fails to reach an agreement then, as indicated in the example of FIG. 2, flow of the inventive operations is routed to the wait for next match operation 140. As is also shown in the view of FIG. 2, the negotiate operation 150 will generally also be monitored (as shown by the monitor operation 136) such that the managers 30 can assist in the negotiations (while role playing the simulated advanced AI interface persona), if required.

Indicated in the view of FIG. 1 are a transaction success decision operation wherein the human monitor 30 determines if a transaction has been successfully completed. If not, then in an escalate operation 162 the monitor 30 optionally directs the problem to the “real” state of the art AI as designated by a AI attempt operation 164. In an AI success decision operation 166 the monitor 30 directs the problem, as necessary to a final resort operation 168 wherein the human monitor 30 (still in the personal of AI) takes whatever action is necessary, such as to personally complete a transaction (where possible,), renegotiate with one or another of the parties, notify a party of the impossibility of a transaction, or the like.

FIG. 6 is a block layer diagram 300 depicting a conceptual perspective of the present invention. One skilled in the art will be familiar with such layer diagrams. As can be seen in the view of FIG. 6, the layer diagram 300 includes a hardware layer which includes computer and network hardware, as described previously herein. A software application layer 304 is the software for practicing the invention, as described previously herein. A state of the art AI layer 306 is used, as also has been discussed previously herein. One skilled in the art will recognize that the hardware layer 302, the software application layer 304 and the AI layer 306 are found in conventional prior art computer and network systems. What distinguishes the present invention is a human intelligence layer 308 which, as described previously herein, pervades essentially the entire operation of the inventive simulated artificial intelligence system 10 and method 100. Only by the interweaving of computerized functions and human intelligences, as described and claimed herein, can the present state of the art systems achieve the advantages of the best of both computerized artificial intelligence and human intelligence.

Various modifications may be made to the invention without altering its value or scope. For example, although the invention has herein before been discussed using the computers 14 (FIG. 1) for communication by the users 16 (the seekers 16a and the providers 16b through the simulated advanced AI interface), one skilled in the art will recognize that there are other potential apparatus for communicating with the brokering computer 19 which could be employed. For example, a personal digital assistant (“PDA”) 200 could be used to communicate with the brokering computer 19 over the Internet, as could an augmented reality system, or and instant messaging system that has been structured to work with the simulated advanced AI interface of the invention. Also, a telephone 202 could communicate with the brokering computer 19, for example through a voice/tone recognition unit 204. Such communication could be through the Internet 12, as shown in the example of FIG. 1 or, alternatively such communication could be through conventional telephone communications channels.

Another example of a variation of the invention would be where the user 16 (such as the seeker 16a) is a machine, rather than a human. For example, essentially any computer controlled device such as a refrigerator, a security system, a video cassette recorder, a personal computer, an industrial machine, a satellite, a ground vehicle, an aircraft, a boat, and so on that uses Java (or a similar language) to communicate over the Internet, or someday (when the state of the art has sufficiently advanced), real AI simulation of human consciousness that behaves much like a real person would. These devices could be pre-programmed to seek information of a specific type under certain conditions and to have pre-defined negotiating limits. It should be noted that such devices could be considered to be “indirect”, “delayed”, or “conditional” human seekers 16a because all such non-human devices would have been programmed by humans to accomplish the actions described. Such an ability could solve a common problem that exists with automatic devices that encounter situations that are outside the parameters for which they were programmed because the inventive method would always ensure they were escalated to an appropriate human manager or processor who could resolve them properly.

As just one example of a possible non-human seeker 16a, a global positioning system (“GPS”) in a rented truck could be programmed to negotiate different insurance rates if the driver took it outside a predefined area. Its programming might specify the insurance agencies to contact, and the amount of coverage to request and the like, and might be further programmed to accept the lowest of the rates received from the agencies (the providers 16b, in this example). The system might potentially even be programmed to respond to requests for further information from the agencies, or the like.

Yet another example of a possible non-human seeker 16a would be an industrial robot programmed to detect a difference in quality of raw materials and to email the quality inspectors, the raw material supplier, and/or other experts to ask if it should cease working or modify some parameter to compensate. The robot could be pre-programmed to negotiate for advice as long as it cost less than, for example $5,000,000, which would be worth while if the cost to the robots owner were, for example $5,000,000 if the robot were to stop working. These are just two of a great many possible examples of non-human seekers 16a.

Yet another likely modification would be to increase the use of artificial intelligence within the system as state of the art AI becomes more powerful, as is a likely to occur as technology advances. For example, one use of AI could be an expert system to screen registration forms or automate other administrative tasks before they are escalated to be performed by a human processor.

An expert system based on knowledge extracted from human managers and processors could be “reinvested into the state of the art AI in the invention and used to automate an increasing number of manager and processor tasks over time. Human managers and processors could never be completely replaced (because part of the essence of the invention is that it is a hybrid system of automated processes and conscious, volitional human behavior), but their numbers could be reduced and their time focused on problems that cannot be automated, thereby reducing operating costs.

All of the above are only some of the examples of available embodiments of the present invention, but by no means the only ones. Those skilled in the art will readily observe that numerous other modifications and alterations may be made without departing from the spirit and scope of the invention. Accordingly, the above disclosure is not intended as limiting and the appended claims are to be interpreted as encompassing the entire scope of the invention.

### INDUSTRIAL APPLICABILITY

The inventive method for a simulated advanced AI interface and simulated AI method 100 and system 10 are intended to be widely used for the brokering of intangibles or tangible goods over the Internet or by other communication means. Although the invention has been described herein in terms of the negotiation for expertise, services, information, and the like, it is anticipated that an advantage of the present invention is that essentially anything can be negotiated using the present inventive method and hybrid system that seamlessly combines standard networked computer automation, state of the art AI processing, and simulated advanced AI capabilities by using real human consciousness to perform tasks that are not yet possible with current technology. Indeed, such flexibility is an important advantage of the invention.

It is another characteristic of the present invention that the anonymity of persons offering a personal service can be maintained. As was pointed out, this is desirable to create the illusion for users that they are dealing with an advanced AI computer intelligence, not other people or a state of the art AI system. Therefore, information and expertise which has heretofore resided only in the minds of human experts, and has not generally been available over the Internet, will seem to the end users to be much like information and expertise obtained from data bases over the Internet using conventional search engines, except that it will be provided by a simulated advanced AI interface, and will, therefore, be easier to obtain. The present invention provides a substantial and important improvement to the scope of information, which is available over the Internet because there are real human search experts finding and providing real human expertise for requests that state of the art computer programs and AI systems cannot satisfy. A unique and important aspect of the present invention is that human monitors oversee each operation and step of what might otherwise be, and appears to outside users to be, a completely automated system. Only through the unique combination of computerized artificial intelligence and human oversight can the best advantages of both artificial intelligence and human insight and intelligence be attained.

In addition to the examples described above, the present invention has application in a number of other areas as follows:

In business: There are many areas in a large business where brokered expertise can be extremely profitable to an organization, expertise that is already available in the minds of an organization's people, but uncataloged and untapped. For example, many potential expertise Providers in a business organization, such as its executives, middle managers, engineers, scientists, staff employees, vendors, or even customers posses volumes of knowledge and expertise both in and outside their job roles, but that fact may not be known to the Seekers of the information or expertise because there is no index of it and means to access it. In addition, even if such access were available, it might not be possible for Seekers to ask for expert advice from many of these Providers because there are organizational political situations that would make it uncomfortable or inappropriate for an executive or customer, for example, to share information or expertise unless it could be done anonymously. This invention's technology can make it possible for organizations to broker their Provider's expertise anonymously and when appropriate, and it can enable a business to tap a new resource.

For Telephone Answering Systems: In recent years, it has become almost impossible to call an organization for help and talk to someone who can provide expert advice without fumbling one's way through endless menus of choices in automatic telephone answering systems, menus that almost never seem to fit the problem one has. This invention can improve this frustrating situation by using simulated AI personas instead of databases of menus and by efficiently escalating callers to human experts role playing AI personas. The overall effect can be faster more friendly service to callers who are desperate to get some small piece of information or expert advice from an organization to solve a pressing problem they have.

By Providing Quick Access to Expertise Over Networks: As explained in the description above, there are many individuals who need information or expertise as evidenced by the popularity of search engines and other similar sites on the Internet. However, using Internet web sites is often difficult or confusing and sometimes produces frustratingly few good results. To be able to access what seems to be a Star Trek™ like computer that offered information and expertise for a reasonable cost would very likely be in high demand. This invention's technology can not only provide such a service, but at the same time, it can create an opportunity for millions of potential Providers of expertise and information to offer their services where they would have no effective way of doing so on their own.

Brokering Expertise for Technical Support: We live in a technological age, and there is no end to peoples' need for answers to their problems with technology. Since the Internet connects millions of people together, it offers a powerful medium for brokering the technical expertise of the Providers who have it to the Seekers who need it. This invention's technology can provide the means of bringing these two groups together in a practical and efficient manner.

For Cool New AI Network Games: A wide variety of games are now able to be played over the Internet. This invention's technology can enable a combination of ordinary network games, AI enhanced network games with various character personas, and seemingly very advanced, futuristic AI games enhanced with very human like character personas masking anonymous, real people who role play AI or robot characters. This arrangement can offer a whole new range of exciting possibilities in the game playing market for the Internet.

For Defense Applications (including language translation): Modern technology is changing the battlefield quickly. The U.S. Army's Land Warrior system already links platoons of soldiers together with each other and their commanders within a network and connects their GPS systems with battle field maps. There are other functions that enable them to send pictures and other data to their command center and receive updated orders. However, no matter how good their training, unless they have seen battle many times, their experience and expertise can be limited. This invention's technology can make the battle tested expertise of more experienced soldiers available to freshly trained soldiers or those with less experience through the battlefield network. And, by adding expert human translators to the system (who can be located anywhere in the world and linked via satellite), This invention's technology can augment extant computer based translation systems by escalating complex or difficult exchanges to real people for translation. Of course, given the way This invention's technology works, to the soldiers and the person being interrogated, the system would seem like the Star Trek™ universal translator system.

For Augmented Reality (AR) and structured Instant Messaging Systems: Over the next few years as computer components become smaller and more powerful, AR systems will become more an more prevalent. In addition, many AR systems will include Instant Messaging as an integral feature, using state of the art AI personas as an interface. Both for defense and civilian uses, AR will offer faster and easier access to network resources than ever before. This means that users will exhaust the preprogrammed responses of network systems faster than ever and become frustrated even sooner than they are now, if the automated responses of network systems are unable to provide users what they seek. This invention's technology can make AR systems much more useful by providing nearly instantaneous access to anonymous human experts anywhere in the world, experts who can provide what the users need on a timely basis. Since the inventive expertise brokering system and simulated advanced AI interface 10 and associated method 100 of the present invention may be readily implemented, and since the advantages as described herein are provided, it is expected that it will be readily accepted in the industry. For these and other reasons, it is expected that the utility and industrial applicability of the invention will be both significant in scope and long lasting in duration.

NOTICE: This correspondence chart is provided for informational purposes only. It is a part of the official Patent Application.

### CORRESPONDENCE CHART

10 INTERNET BASED SIMULATED ARTIFICIAL INTELLIGENCE SYSTEM

12 INTERNET

14 COMPUTERS

16 USERS

16a SEEKER

17 ADDITIONAL PROVIDERS

18 VIRTUAL PRIVATE NETWORK

19 BROKERING COMPUTER

20 FIREWALL

22 PUBLIC KEY INFRASTRUCTURE UNIT

24 E-COMMERCE SERVER

26 MANAGER COMPUTERS

28 LOCAL AREA NETWORK

30 MANAGER

32 REMOVABLE MEDIA DRIVE

32 REMOVABLE MEDIA

36 DISPLAY SCREEN

38 KEYBOARD

40 POINTING DEVICE

42 PROVIDER DATA BASE

44 SEEKER DATA BASE

100 SIMULATED ARTIFICIAL INTELLIGENCE METHOD

102 PROVIDER REGISTRATION

104 SEEKER REGISTRATION

106 REGISTRATION SCREEN

108 NAME FIELD

110 ADDRESS FIELD

112 PHONE FIELD

114 EMAIL FIELD

116 PROVIDER INFORMATION OPERATION

117 SELLER'S OFFER

118 PROVIDER INFORMATION SCREEN

120 SERVICE FIELD

122 PRICE FIELD

123 TIME FIELD

124 SEEKER INFORMATION OPERATION

125 BUYER'S REQUIREMENTS

126 SEEKER INFORMATION SCREEN

128 SERVICE DESIRED FIELD

129 TIME NEEDED FIELD

130 OFFER PRICE FIELD

131 PAYMENT METHOD FIELD

132 SEND PROVIDER INFORMATION OPERATION

134 SEND SEEKER INFORMATION OPERATION

136 MONITOR OPERATION

138 MATCHING OPERATION

140 WAIT FOR NEXT MATCH OPERATION

142 NOTIFY OF MATCH OPERATION

144 PROVIDER SEND WORK PRODUCT OPERATION

146 PAYOUT OPERATION

148 NOTIFY OF NEAR MATCH

150 NEGOTIATION OPERATION

152 AGREEMENT DECISION OPERATION

200 PERSONAL DIGITAL ASSISTANT

202 TELEPHONE

204 VOICE/TONE RECOGNITION UNIT

I claim:

1. A simulated artificial intelligence system, comprising:
a buyer registration module for obtaining information about a buyer's requirement;
a seller registration module for obtaining information about a seller's offer;
a matching module for matching the buyer's requirement to the seller's offer; and
a human interface whereby a human operator checks the operation of each of the buyer registration module, the seller registration module, and the matching module.

2. The system of claim 1, and further including:
a negotiation module for allowing the buyer and the seller to negotiate any difference between the buyer's requirement and the seller's offer.

3. The system of claim 1, wherein:
the seller's offer includes a description field of an offered service, and the buyer's requirement includes a description field of a desired service.

4. The system of claim 1, wherein:
the seller's offer includes a price field, and the buyer's requirement includes an offered price field.

5. The system of claim 1, wherein:
the seller's offer includes a time field, and the buyer's requirement includes a desired time field.

6. The system of claim 1, wherein:
the seller's offer is an offer to provide a service.

7. The system of claim 1, wherein:
the buyer's requirement is a request for information.

8. The system of claim 1, wherein:
the buyer's requirement is a request for expertise.

9. A computer program product comprising a computer usable medium having a computer readable code embodied thereon configured to operate on a computer, comprising:
a first registration routine for registering a seller's offer;
a second registration routine for registering a buyer's requirement;
a matching routine for matching the seller's offer to the buyer's requirement; and
a human monitor routine for allowing a human operator to review the results of at least the matching routine and further to intervene in the matching routine.

10. The computer program product of claim 9, and further including:
a negotiation routine for allowing a seller and a buyer to reconcile the seller's offer and the buyer's requirement.

11. The computer program product of claim 9, and further including:
the seller's offer includes an offer to provide a service; and
the buyer's requirement includes a recitation of a service needed.

12. The system of claim 9, wherein:
the seller's offer includes a recitation of a price desired for the performance of a service; and
the buyer's requirement includes a recitation of an acceptable price for a service.

13. The system of claim 9, wherein:
the seller's offer includes a recitation of a time within which a service can be performed; and
the buyer's requirement includes a recitation of a time in which it is desired that a service be performed.

14. A method for simulating artificial intelligence, comprising:
recording a provider's offer of a service;
recording a seeker's request for a service;
matching the provider's offer to the seeker's request; and
checking the results of at least each iteration of the matching operation by a human operator.

15. The method of claim 14, and further including:
notifying the seeker of a match between the provider's offer and the seeker's request;
notifying the provider of the match between the provider's offer and the seeker's request;
waiting until the service is provided from the provider to the seeker; and
debiting the seeker and crediting the seller.

16. The method of claim 14, and further including:
notifying the seeker and the provider of a near match between the provider's offer and the seeker's request; and
negotiating to reconcile the seeker's request and the provider's offer.

17. A simulated artificial intelligence system for brokering transactions over the Internet, comprising:
a brokering computer connected to the Internet, said brokering computer having a provider data base and a seeker data base;
a matching routine for correlating the provider data base with the seeker data base; and
a human operator interface whereby a human operator monitors each of the transactions.

18. The simulated artificial intelligence system of claim 17, wherein:
the human operator checks at least each of a plurality of proposed transactions.

19. The simulated artificial intelligence system of claim 17, wherein:
the human operator checks at least each of a plurality of matching operations.

20. The simulated artificial intelligence system of claim 17, wherein:
the human operator optionally directs transactions to a computerized artificial intelligence.

21. The simulated artificial intelligence system of claim 17, wherein:
the human operator personally performs the matching operation.

22. The simulated artificial intelligence system of claim 17, wherein:
the human operator maintains the persona of the system.
